(19) United States
(12) Patent Application Publication
(10) Pub. No.: US 2002/0042533 A1
(43) Pub. Date: Apr. 11, 2002

(54) Organosilicon compounds

(76) Inventors: Christoph Batz-Sohn, Hanau-Mittelbuchen (DE); Rudolf Michel, Freigericht (DE); Hans-Detlef Luginsland, Koln (DE)

Correspondence Address: SMITH, GAMBRELL & RUSSELL, LLP, ATTORNEYS AT LAW, SUITE 800, 1850 M STREET, N.W., WASHINGTON, DC, 20036, US

(21) Appl. No.: 09/931,163

(22) Filed: Aug. 17, 2001

(30) Foreign Application Priority Data
Aug. 18, 2000 (EP) 00 117 799.7

(51) Int. Cl. C07F 7/04

(52) U.S. Cl. 556/482

(57) ABSTRACT

Organosilicon compounds of the formula I

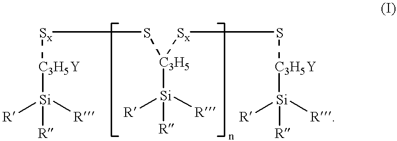

The organosilicon compounds are prepared from a compound of the general formula (II)

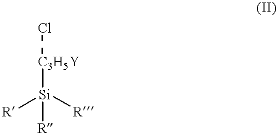

by reaction with MSH, M₂S_{z} or M₂S/S. The organosilicon compounds can be used in rubber mixtures.

### INTRODUCTION AND BACKGROUND

The present invention relates to organosilicon compounds, a process for their preparation and their use in rubber mixtures.

It is known to employ sulfur-containing organosilicon compounds, such as 3-mercaptopropyltrimethoxysilane or bis-(3-[triethoxysilyl]-propyl)tetrasulfane, as a silane adhesion promoter or reinforcing additive in rubber mixtures with an oxide filler content, such as, for example, for treads and other components of car tires (DE 2 141 159, DE 2 212 239, U.S. Pat. No. 3,978,103, U.S. Pat. No. 4,048,206).

It is furthermore known that sulfur-containing silane adhesion promoters are used in the preparation of sealing compositions, casting moulds for metal casting, paint and protective coating films, adhesives, asphalt mixtures and plastics with an oxide filler content, fixing of active compounds and functional units on inorganic carrier materials, for example in the immobilization of homogeneous catalysts and enzymes, fixed bed catalysts and in liquid chromatography.

It is known from EP 0 969 033 that sulfur-functional organosilanes which have more than one polysulfane function per silicon unit and therefore form polymeric or oligomeric structures have an improved profile of properties in rubber mixtures due to increased coupling yields. However, these silanes have the disadvantage that the olefinic dichlorides required as a raw material for their preparation, such as, for example, 3,4-dichlorobutene, are not available in large-scale industrial amounts.

In the preparation of 3-chloropropyltrichlorosilane, which is required in large amounts as a starting material for the preparation of organofunctional silanes, such as, for example, 3-mercaptopropyltrimethoxysilane or bis-(3-[triethoxysilyl]-propyl)tetrasulfane, propyltrichlorosilane (PTS) is formed by an undesirable side reaction (EP 0 519 181). This side reaction additionally consumes the trichlorosilane, which is currently scarce as a raw material, and as a result makes the process for preparation of the abovementioned adhesion promoters expensive.

Disadvantages of the known organosilicon compounds are the expensive starting compounds or the formation of by-products such as propyltrichlorosilane.

An object of the present invention is to develop new adhesion promoters for rubber uses which are based on the by-product propyltrichlorosilane.

### SUMMARY OF THE INVENTION

The present invention provides organosilicon compounds, which are characterized in that these correspond to the formula I

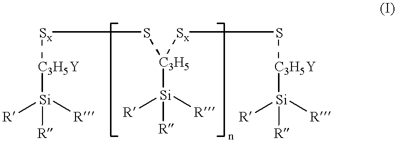

wherein

R′, R″, R″′ independently of one another denote (C₁- C₄)alkoxy, (C₁- C₄)haloalkoxy or Cl and Y, denotes H or Cl,

x=0−6 and

n=0−30.

The “. . . ” in formula (I) represent a chemical bond, which can be bonded to any of the three C atoms of the C₃H₅(Y) group, and the 5 hydrogens and the group Y occupy the particular free valencies.

The invention also provides a process for the preparation of organosilicon compounds of the formula I, which is characterized in that compounds of the formula (II) and/or mixtures thereof

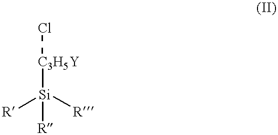

wherein R′, R″, R′″, Y and “. . . ” have the meaning according to formula I, are reacted with MSH, M₂S_{z} or with M₂S/S, wherein M is an ammonium ion or metal ion, for example sodium ion or potassium ion, and z is, as a statistical average, a number between 2 and 6.

In one embodiment of the process according to the invention, the reaction can be carried out in a solvent, preferably in an inert solvent or mixtures thereof, such as in an aromatic solvent, for example chlorobenzene, a halogenated hydrocarbon, for example chloroform or methylene chloride, an ether, for example diisopropyl ether, tert-butyl methyl ether, tetrahydrofuran or diethyl ether, acetonitrile, carboxylic acid esters, for example ethyl acetate, methyl acetate or isopropyl acetate, an alcohol, for example methanol, ethanol, n-propanol, i-propanol, n-butanol, sec-butanol or tert-butanol.

The reaction temperatures can range from 20° C. to 150° C., preferably 35° C. to 100° C., particularly preferably 55° C. to 85° C.

The reaction can optionally be carried out under catalytic conditions under pressures between normal pressure or an increased pressure of up to 6 bar.

The compound of the formula II can be added to a suspension of MSH, M₂S/S or M₂S_{z} in a solvent.

The duration of the reaction can be up to 24 h, preferably 1 to 8 h.

After the end of the reaction, the precipitate formed can be filtered off and the solvent can be removed.

The compounds of the formula I according to the invention can remain as clear, yellow- to red-coloured liquids.

In a preferred embodiment, ethanol can be used as the solvent. The reactions can preferably be carried out under absolute conditions, that is to say under exclusion of moisture. Predried solvents, such as, for example, analytical grade ethanol, can be used.

Sodium can be used particularly suitably as the metal ion of the compounds MSH, M₂S_{z}, M₂S.

Processes for sulfidization are described in JP 722 8588, U.S. Pat. No. 5,405,985 and U.S. Pat. No. 5,466,848. The reaction can be carried out under catalysis. The catalyst can be employed here in catalytic or stoichiometric amounts.

Compounds of the formula(II) and/or mixtures thereof can be prepared by suitable reactions (e.g. alkoxy compounds by alcoholysis, haloalkoxy compounds by reaction with haloalcohols) from mixtures of the compounds of the general formula (III)

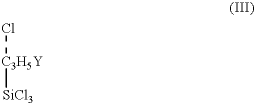

wherein Y and “. . . ” have the abovementioned meaning. Compounds of the general formula (III) and/or mixtures thereof can be prepared by thermal chlorination of propyltrichlorosilane (PTS)

Cl₃Si—C₃H₇+C1₂→Cl . . . C₃H₅Y-(SiCl₃)+HCl

at temperatures of 70° to 1 50° C. Propyltrichlorosilane and chlorine can be used in a molar ratio of 1:0.5 to 1:⅙. This reaction requires no catalysts or light at all. The trichlorosilyl group of organochlorosilanes is inert towards chlorination, that is to say no SiCl₄, for example, is split off.

The reaction can expediently be carried out in the liquid phase at the boiling point of propyltrichlorosilane. The chlorine gas can be dried beforehand and passed in finely divided gaseous form through the reaction mixture. The HCl formed as a by-product can leave the system via a reflux condenser. The chlorination can expediently be carried out with a high deficit of chlorine, in order to avoid statistically the formation of dichlorides. Analogous processes are known and are used on a large industrial scale, for example, for the preparation of mono-chloroalkanes (Ullmann volume 9, “Chlorkohlenwasserstoffe, aliphatische [Chlorohydrocarbons, aliphatic]”). These chlorinations can be carried out such that a part of the chlorination mixture, which contains a high excess of propyltrichlorosilane, is constantly separated into educt and product by distillation, and the educt, propyltrichlorosilane, is fed back into the reaction space. A continuous procedure thus exists, and the formation of undesirable dichloropropyltrichlorosilanes is suppressed to the greatest extent. Propyltrichlorosilane (PTS), the three possible isomers thereof, 1-chloropropyltrichlorosilane, 2-chloropropyltrichlorosilane and 3-chloropropyltrichlorosilane (ratio approx. 1:4:4), and the products with a higher degree of chlorination formed to a small extent can be separated by distillation.

The invention also provides rubber mixtures, which are characterized in that they comprise rubber, filler, preferably precipitated silica and/or carbon black, at least one organosilicon compound of the formula (I) and optionally further rubber auxiliaries.

In addition to naturally occurring rubber, synthetic rubbers are also suitable for the preparation of the rubber mixtures according to the invention. Preferred synthetic rubbers are described, for example, in W. Hofmann, Kautschuktechnologie [Rubber Technology], Genter Verlag, Stuttgart 1980. They include, inter alia,

polybutadiene (BR)

polyisoprene (IR)

styrene/butadiene copolymers with styrene contents of 1 to 60, preferably 5 to 50 wt. % (SBR)

isobutylene/isoprene copolymers (IIR)

butadiene/acrylonitrile copolymers with acrylonitrile contents of 5 to 60, preferably 10 to 50 wt. % (NBR)

ethylene/propylene/diene copolymers (EPDM)

and mixtures of these rubbers.

The rubber mixtures according to the invention can comprise further rubber auxiliary products which are known in the rubber industry, such as, inter alia, reaction accelerators or retardants, anti-ageing agents, stabilizers, processing auxiliaries, plasticizers, waxes, metal oxides and activators, such as triethanolamine, polyethylene glycol, hexanetriol.

The rubber auxiliaries are employed in conventional amounts, which depend, inter alia, on the intended use. Conventional amounts are, for example, amounts of 0.1 to 50 wt. %, based on the rubber.

Sulfur or organic sulfur donors can serve as crosslinking agents. The rubber mixtures according to the invention can furthermore comprise vulcanization accelerators.

Examples of suitable vulcanization accelerators are mercaptobenzothiazoles, sulfenamides, guanidines, thiurams, dithiocarbamates, thioureas and thiocarbonates.

The vulcanization accelerators and sulfur can be employed in amounts of 0.1 to 10 wt. %, preferably 0.1 to 5 wt. %, based on the rubber.

The mixing of the rubbers with the filler, optionally rubber auxiliaries and the organosilanes can be carried out in conventional mixing units, such as roll mills, internal mixers and mixing extruders. Such rubber mixtures are conventionally prepared in internal mixers, the rubbers, the filler, the organosilanes and the rubber auxiliaries first being mixed in at 100 to 170° C. in one or more successive thermomechanical mixing stages. The sequence of addition and the time of addition of the individual components can have a decisive effect on the resulting mixture properties here. The crosslinking chemicals are then conventionally added to the rubber mixture obtained in this way in an internal mixer or on a roll mill at 40-110° C. and the mixture is processed to the so-called crude mixture for the subsequent process steps, such as, for example, shaping and vulcanization. The vulcanization of the rubber mixtures according to the invention can be carried out at temperatures of 80 to 200° C., preferably 130 to 180° C., optionally under a pressure of 10 to 200 bar.

The rubber mixtures according to the invention are suitable for the production of shaped articles, for example for the production of pneumatic tires, tire treads, cable sheathings, hoses, drive belts, conveyor belts, roller coverings, tires, shoe soles, sealing rings and damping elements.

The process according to the invention has the advantage that the by-product propyltrichlorosilane obtained in the preparation of bis- (3-[triethoxysilyl]-propyl) tetrasulfane is utilized in an appropriate manner.

An easy and inexpensive access to sulfur-functional adhesion promoters is obtained by the thermal chlorination of propyltrichlorosilane (PTS). The mode of action as an adhesion promoter in rubber mixtures is identical to that of bis-(3-[triethoxysilyl]-propyl)tetrasulfane. At an increased content of polysulfane functions per silicon unit, which can be achieved by over-stoichiometric chlorination, the activity as an adhesion promoter can even be increased.

### DETAILED EMBODIMENT OF THE INVENTION

### EXAMPLES

### Example 1

### Chlorination of propyltrichlorosilane (PTS)

500 g propyltrichlorosilane are initially introduced into a 11 four-necked flask with a gas inlet tube, dropping funnel, reflux condenser, heating mushroom and internal thermometer and are heated to the reflux temperature. Approx. 400 ml of liquid per hour are removed via an outlet at the base of the flask by means of a metering pump and are introduced on to a distillation column capable of separating off the chlorinated products cleanly as the bottom product. The top product of this column thus comprises almost pure propyltrichlorosilane, which flows back into the reaction flask. After a stable circulation has formed here, metering of 40 g per hour of chlorine gas, which has been dried beforehand by being passed through concentrated sulfuric acid, is started. At the same time, 100 g propyltrichlorosilane per hour are metered in via the dropping funnel, so that overall a continuous operation results. After a stationary operating state has been established, approx. 120 g of chlorinated product per hour are drawn off at the base of the column. A four-fold molar excess of propyl-trichlorosilane results mathematically in the chlorination by this procedure, so that the formation of dichlorides is suppressed.

According to gas chromatography, the product formed has the following composition (wt %): 9.95% 1-chloropropyltrichlorosilane, 42.11% 2-chloropropyltrichlorosilane, 45.48% 3-chloropropyltrichlorosilane and 2.73% dichlorinated products (6 isomers in total).

### Example 2

413 ml ethanol (10% excess) are added dropwise to 460.5 g of the product mixture from example 1 in a 1 l three-necked flask with a gas inlet tube, reflux condenser and stirrer, while passing N₂ through (in order to drive off the HCl formed). When the addition has ended, the mixture is heated for a further 1 h, while stirring. After cooling, the reaction mixture is neutralized by addition of 50 ml sodium ethanolate and then filtered. 492.1 g of a clear liquid are obtained, this being identified by NMR analysis as a mixture of 30% 3-chloropropyltriethoxysilane, 33% 2-chloropropyltriethoxysilane, 8% 1-chloropropyltriethoxysilane and small amounts of other compounds.

### Example 3

158.9 g of the silane mixture from example 2 are dissolved in 160 ml ethanol and the solution is mixed with 34.9 g sulfur. 28.3 g dried Na₂S are then added, the heat of reaction bringing the stirred reaction mixture to the boiling point. The mixture is allowed to react for 2 h under reflux and cooled and the solid which has formed is filtered off. After the solvent has been distilled off, 141.9 g of a red, clear liquid remain which, according to elemental analysis, comprises 19.8 wt. % sulfur.

### Example 4

The recipe used for the rubber mixtures is given in the following table 1. The unit phr here means parts by weight per 100 parts of the crude rubber employed. The general process for the preparation of rubber mixtures and vulcanization products thereof is described in the following book: “Rubber Technology Handbook”, W. Hofinann, Hanser Verlag 1994.

TABLE 1

| | |
|---|---|
| | Ex. |
| Substance | (phr) |

| | |
|---|---|
| 1st stage | |
| Buna VSL 5025-1 | 96 |
| Buna CB 24 | 30 |
| Ultrasil 7000 GR | 80 |
| ZnO | 3 |
| Stearic acid | 2 |
| Naftolen ZD | 10 |
| Vulkanox 4020 | 1.5 |
| Protector G 35 P | 1 |
| Silanes according to ex. | variable |
| 2nd stage | |
| Batch stage 1 | |
| 3rd stage | |
| Batch stage 2 | |
| Vulkacit D | 1 |
| Vulkacit CZ | 1.5 |
| Sulfur | variable |

The polymer VSL 5025-1 is an SBR copolymer of Bayer AG polymerized in solution and having a styrene content of 25 wt. % and a butadiene content of 75 wt. %. Of the butadiene, 73% is linked as 1,2, 10% as cis-1,4 and 17% as trans-1,4. The copolymer comprises 37.5 phr oil and has a Mooney viscosity (ML 1±4/100° C.) of 50±4.

The polymer Buna CB 24 is a cis-1,4-polybutadiene (neodymium type) from Bayer AG with a cis-1 ,4 content of 97%, a trans-1,4 content of 2%, a 1,2 content of 1% and a Mooney viscosity of 44±5.

Naftolen ZD from Chemetall is used as the aromatic oil. Vulkanox 4020 is 6PPD from Bayer AG, and Protector G35P is an anti-ozone wax from HB-Fuller GmbH. Vulkacit D (DPG) and Vulkacit CZ (CBS) are commercial products from Bayer AG.

Ultrasil 7000 GR is a readily dispersible precipitated silica from Degussa-Hüls AG with a BET surface area of 170 m²/g. The monofunctional silane hexadecyltriethoxysilane (HDTES) from Degussa-Hüls AG is used as a reference substance.

The rubber mixtures are prepared in an internal mixer in accordance with the mixing instructions in table 2.

TABLE 2

| | |
|---|---|
| Stage 1 | |
| Settings | |
| Mixing unit | Werner & Pfleiderer E-type |
| Speed | 70 min⁻¹ |
| Plunger pressure | 5.5 bar |
| Empty volume | 1.58 L |
| Filling level | 0.56 |
| Flow temp | 80° C. |
| Mixing operation | |
| 0 to 1 min | Buna VSL 5025-1 + Buna CB 24 |
| 1 to 3 min | ½ silica, ZnO, |
| | stearic acid, Naftolen ZD, silane |
| 3 to 4 min | ½ silica, anti-ageing |
| 4 min | clean |
| 4 to 5 min | mix |
| 5 min | clean |
| 5 to 6 min | mix and deliver |
| Batch temp. | 145-150° C. |
| Storage | 24 h at room temperature |
| Stage 2 | |
| Settings | |
| Mixing unit | as in stage 1 except: |
| Speed | 80 min⁻¹ |
| Flow temp. | 80° C. |
| Filling level | 0.53 |
| Mixing operation | |
| 0 to 2 min | break up batch stage 1 |
| 2 to 5 min | keep batch temperature 150° C. by |
| | varying the speed |
| 5 min | deliver |
| Batch temp. | 150° C. |
| Storage | 4 h at room temperature |
| Stage 3 | |
| Settings | |
| Mixing unit | as in stage 1 except |
| Speed | 40 min⁻¹ |
| Filling level | 0.51 |
| Flow temp | 50° C. |
| Mixing operation | |
| 0 to 2 min | batch stage 2, accelerator, sulfur |
| 2 min | deliver and form skin on laboratory roll mill, |
| | (diameter 200 mm, length 450 mm, |
| | flow temperature 50° C.) |
| | Homogenization: |
| | cut in 3* left, 3* right and |
| | fold over and |
| | turn over 8* for a wide roll nip (1 mm) and |
| | 3* for a narrow roll nip (3.5 mm) |
| | draw out a rolled sheet |
| Batch temp | 85-95° C. |

The methods for rubber testing are summarized in table 3.

TABLE 3

| Physical testing | Standard/Conditions |
|---|---|
| ML 1 + 4, 100° C. 3rd stage | DIN 53523/3, ISO 667 |
| Vulcameter test, 165° C. | DIN 53529/3, ISO 6502 |
| Dmax-Dmin (dNm) | |
| t10% and t90% (min) | |
| Tensile test on ring, 23° C. | DIN 53504, ISO 37 |
| Tensile strength (MPa) | |
| Moduli (MPa) | |
| Elongation at break (%) | |
| Shore A hardness, 23° C. (SH) | DIN 53 505 |
| Viscoelastic properties, | DIN 53 513, ISO 2856 |
| 0 to 60° C., 16 Hz, 50N preload | |
| and 25N amplitude load | |
| Storage modulus E′ (MPa) | |
| Loss modulus E″ (MPa) | |
| Loss factor tan □ □ () | |
| Ball rebound, 23° C. (%) | ASTM D 5308 |
| DIN abrasion, 10 N load (mm³) | DIN 53 516 |
| Dispersion () | ISO/DIS 11345 |

In the example, reference mixture (A) with 5 phr of the alkylsilane hexadecyltriethoxysilane and 2.2 phr sulfur is compared with mixture (B), which comprises 6.4 phr of the silane according to example 3 according to the invention and 1.5 phr sulfur. The amounts of sulfur are chosen such that the amounts of mobile sulfur are comparable. The alkylsilane hexadecyltriethoxysilane hydrophobizes exclusively the silica. No bonding to the rubber can take place.

Table 4 shows the result of the rubber testing. Mixture (A) is vulcanized at 165° C. for 40 minutes and mixture (B) for 20 min.

TABLE 4

| | | (A) | (B) |
|---|---|---|---|
| ML (1 + 4) | (MU) | 50 | 65 |
| Dmax-Dmin | (dNm) | 12.6 | 17.5 |
| t10% | (min) | 3.0 | 1.4 |
| t90% | (min) | 22.0 | 9.9 |
| Shore A hardness | (SH) | 51 | 63 |
| Tensile strength | (MPa) | 10.9 | 16.9 |
| Modulus 100% | (MPa) | 0.9 | 1.7 |
| Modulus 300% | (MPa) | 2.9 | 8.2 |
| Elongation at break | (%) | 660 | 480 |
| DIN abrasion | (mm³) | 203 | 84 |
| Ball rebound | (%) | 27.5 | 33.0 |
| E′ (0° C.) | (MPa) | 11.1 | 14.2 |
| E″ (0° C.) | (MPa) | 5.3 | 6.8 |
| tan δ (0° C.) | () | 0.480 | 0.475 |
| E′ (60° C.) | (MPa) | 5.2 | 6.5 |
| E″ (60° C.) | (MPa) | 0.8 | 0.9 |
| tan δ (60° C.) | () | 0.153 | 0.135 |
| Dispersion | () | 7 | 9 |

As can be seen clearly from the data in table 4, the profile of rubber values of mixture (B) with the silane according to the invention is significantly above that of reference (A). Inter alia, the higher moduli, the lower DIN abrasion and the lower tan δ (60° C.) value demonstrate a coupling reaction between the filler and rubber.

Further variations and modifications of the foregoing will be apparent to those skilled in the art and are intended to be encompassed by the claims appended hereto.

European priority application 00 117 799.7 is relied on and incorporated herein by reference.

We claim:

1. An organosilicon compound, represented by the structural formula I 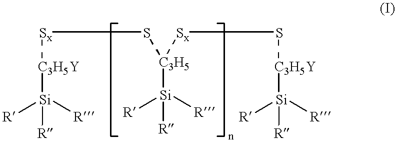
wherein
R′, R″, R′″ independently of one another denote (C₁- C₄)alkoxy, (C₁- C₄)haloalkoxy or Cl and
Y, denotes H or Cl,
x=0−6 and
n=0−30.

2. The organosilicon compound according to claim 1 wherein the dotted bond lines represent a chemical bond which can be bonded to any of the three carbon atoms in the group C₃H₅ (Y).

3. A process for the preparation of an organosilicon compound according to claim 1, comprising reacting a compound of the formula (II). 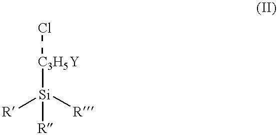
wherein R′, R″, R″′ and Y have the meaning according to formula I,
with MSH, M₂S_{z} or with M₂S/S, wherein M is an ammonium ion or metal ion, and z is, as a statistical average, a number between 2 and 6.

4. The process according to claim 3 further comprising reacting in the presence of a solvent.

5. The process according to claim 3 further comprising reacting at a temperature from 20° to 150° C.

6. The process according to claim 3 wherein the compound of formula II is added to a suspension of MSH, M₂S/S or M₂S in a solvent.

7. The process according to claim 3 further comprising after reacting, filtering off precipitate that is formed and recovering the compound of formula I in the form of a liquid.

8. The process according to claim 3 wherein M is sodium or potassium.

9. The process according to claim 3 wherein water is absent.

10. A process for the preparation of an organosilicon compound according to formula II, comprising reacting a compound of the formula (III). 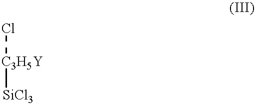
wherein Y has the meaning according to formula I,
with an alcohol or haloalcohol to give a compound of the formula (II).

11. A process for the preparation of an organosilicon compound according to formula III, wherein propyltrichlorosilane is reacted with chlorine at temperatures of 70° to 150° C. to give a compound of the formula (III).

12. The process for the preparation of an organosilicon compound according to claim 11, wherein propyltrichlorosilane and chlorine are used in a molar ratio of 1:0.5 to 1:1/6.

13. A rubber composition containing an organosilicon compound according to claim 1.

14. The rubber composition according to claim 13 which is vulcanizable.

15. The rubbert composition according to claim 13 which is vulcanized.

16. A rubber article made from the rubber composition of claim 13.

17. The rubber article of claim 16 which is a tire, cable sheathing, belt or sealing ring.

18. A rubber mixture comprising rubber, filler, at least one organosilicon compound according to claim 1.
